(19) United States
(12) Patent Application Publication
(10) Pub. No.: US 2004/0179132 A1
(43) Pub. Date: Sep. 16, 2004

(54) Camera system and camera control method

(75) Inventors: Kenji Fujino, Tokyo (JP); Toru Katsurai, Tokyo (JP); Takahiro Takahashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 10/758,353

(22) Filed: Jan. 16, 2004

(30) Foreign Application Priority Data
Mar. 14, 2003 (JP) 2003-069109

(51) Int. Cl. H04N 5/238

(52) U.S. Cl. 348/363

(57) ABSTRACT

The present invention is intended for realizing a camera system and camera control method whereby wide dynamic-range optimum images can be obtained.

The present invention is characterized by improvements made to a camera system for obtaining optimum images by controlling a compression curve for the dynamic range of an image sensor according to the brightness of a subject. The camera system comprises an iris for adjusting the amount of light introduced to the image sensor; an iris driver for driving the iris; an iris controller for determining an iris value according to the image data of the image sensor in order to let the iris driver make an iris value correction accordingly; and a dynamic range adjuster for correcting the compression curve according to the image data of the image sensor.

### BACKGROUND OF THE INVENTION

1. Field of the Invention

The present invention relates to a camera system and camera control method whereby wide dynamic-range optimum images can be obtained and, more particularly, to a camera system and camera control method whereby optimum images can be obtained by controlling a compression curve for the dynamic range of an image sensor according to the brightness of a subject.

2. Description of the Prior Art

A CCD (charge-coupled device) sensor and a CMOS (complementary metal-oxide semiconductor) sensor can be used as image sensors for digitally capturing the image of a subject. CMOS sensors are discussed in, for example, the IEEE Journal of Solid-State Circuits, Vol. 33, No. 12, December 1998, “A 256×256 CMOS Imaging Array with Wide Dynamic-Range Pixels and Column-Parallel Digital Output,” Steven Decker, R. Daniel McGrath, Kevin Brehmer, and Charles G. Sodini. Such a CMOS sensor is explained hereinafter by referring to FIG. 1.

In FIG. 1, photodiode PD is grounded at the cathode thereof. One end of resistor R is connected to the anode of photodiode PD. One end of capacitor C is connected to the other end of resistor R and the other end of capacitor C is grounded. A control signal from a sensor controller, which is not shown in the figure, is input to the gate of FET Q1, the drain thereof is pulled up to voltage Vdd, and the source thereof is connected to the one end of capacitor C. The gate of FET Q2 is connected to the one end of capacitor C, and the drain thereof is pulled up to voltage Vdd. A select signal from a sensor controller, which is not shown in the figure, is input to the gate of FET Q3, and the drain thereof is connected to the source of FET Q2 so that an output is provided from the source.

The behavior of such a CMOS sensor as discussed above is explained hereinafter by referring to FIGS. 2 and 3, wherein FIGS. 2 and 3 are graphical representations illustrating the behavior of the CMOS sensor. FIG. 2(A) is a graph illustrating the relationship between the integration time and control signal (barrier voltage), wherein the horizontal axis represents the integration time and the vertical axis represents the voltage value. FIG. 2(B) is a graph illustrating the input-output characteristics corresponding to the waveform shown in FIG. 2(A), wherein the horizontal axis represents the input luminance and the vertical axis represents the output luminance. It should be noted that a voltage value of 1.25 [V] is indicated as 7 and an integration time of 1/30 seconds is indicated as 512. It should also be noted that the unit of the input luminance is [lx], the maximum value of the output luminance is represented as 255, and the output luminance has no unit of measure. As illustrated in FIG. 2(A), a barrier voltage of 7 is kept input to the FET Q1 of the CMOS sensor during an integral time of 511. As a result, the CMOS sensor provides the input luminance vs. output luminance characteristics illustrated in FIG. 2(B). In this case, the output luminance (bright area) saturates at an input luminance level of as low as 342.

In order to avoid such saturation, the barrier voltage waveform illustrated in FIG. 2(A) is input to the FET Q1 of the CMOS sensor with the integral time of 511 shortened to 25, for example, as indicated by the broken line. This countermeasure causes waveform a in the input-output characteristics graph to change to waveform b, as illustrated in FIG. 4. Thus, the output luminance range changes from y1 to y2 for the input luminance range x, preventing the bright area from becoming saturated. On the contrary, the output luminance change is small in the dark area, causing images to be damaged in the dark area thereof.

For this reason, it is possible to optimally depict both the bright and dark areas if the output luminance change is large in regions where the input luminance is low and if the change is small in regions where the input luminance is high. More particularly, the characteristics of the dynamic range are changed from a linear line to a logarithmic curve, as illustrated in FIG. 3(B). This means that input luminance compression is optimized so that the bright and dark areas are also optimized.

For example, when a ladder-shaped voltage waveform with an integral time of “511” is input as illustrated in FIG. 3(A), the CMOS sensor provides such output luminance as characterized by a polygonal-line quasi-logarithmic curve illustrated in FIG. 3(B) for a given range of input luminance.

As a result, the image information of the dark area remains reasonably intact, enabling the CMOS sensor to provide optimum images.

As a method for automatically setting up such a CMOS sensor as discussed above, the number of pixels whose brightness levels are higher than their brightness threshold is counted for all image data (all pixels) to control the logarithmic compression curve, thereby preventing the bright area from becoming saturated. Such a method is described in US 2002/0191082 A1, for example.

When a compression curve is automatically set up using such a device as discussed above, the resulting compression curve prevents the bright area from becoming saturated if the number of pixels whose brightness levels are higher than their brightness threshold is relatively large. This results in the problem, however, that the black level of the dark area becomes higher.

### SUMMARY OF THE INVENTION

An object of the present invention is to realize a camera system and camera control method whereby wide dynamic-range optimum images can be obtained.

### BRIEF DESCRIPTION OF THE DRAWINGS

FIG. 1 is a circuit diagram illustrating the configuration of a CMOS sensor.

FIG. 2 is a graphical representation illustrating the behavior of the CMOS sensor.

FIG. 3 is another graphical representation illustrating the behavior of the CMOS sensor.

FIG. 4 is yet another graphical representation illustrating the behavior of the CMOS sensor.

FIG. 5 is a block diagram illustrating one embodiment in accordance with the present invention.

FIG. 6 is a flowchart illustrating the behavior of the system shown in FIG. 5.

FIG. 7 is a flowchart illustrating the behavior of iris controller 61.

FIG. 8 is a flowchart illustrating the behavior of dynamic range adjuster 62.

FIG. 9 is a graphical representation illustrating the behavior of the system shown in FIG. 5.

FIG. 10 is a block diagram illustrating another embodiment in accordance with the present invention.

FIG. 11 is a flowchart illustrating the behavior of iris controller 61 shown in FIG. 10.

FIG. 12 is a graphical representation illustrating a histogram of image data.

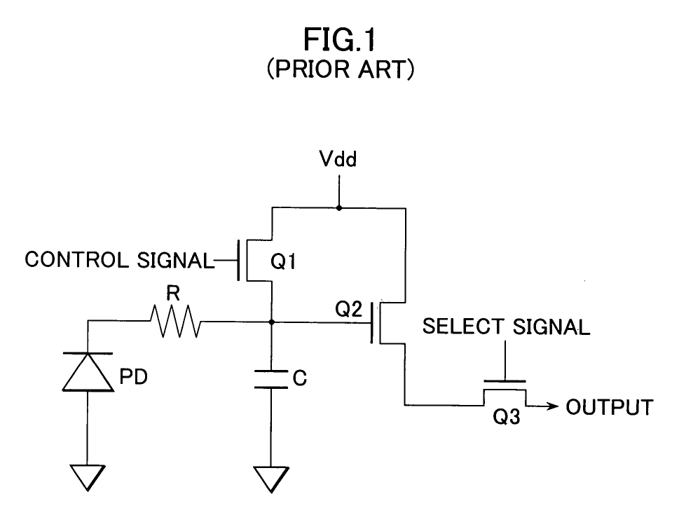

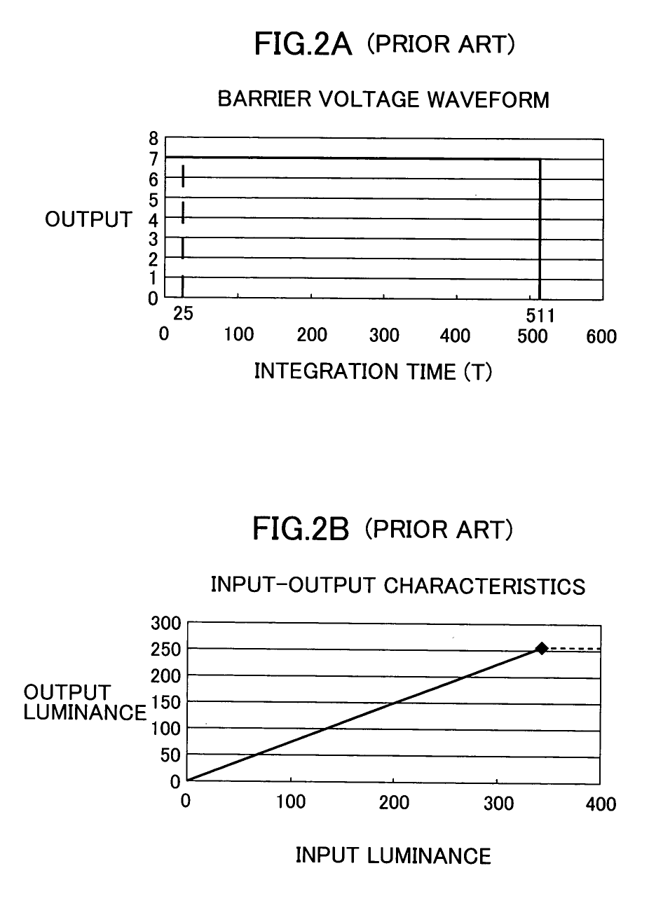

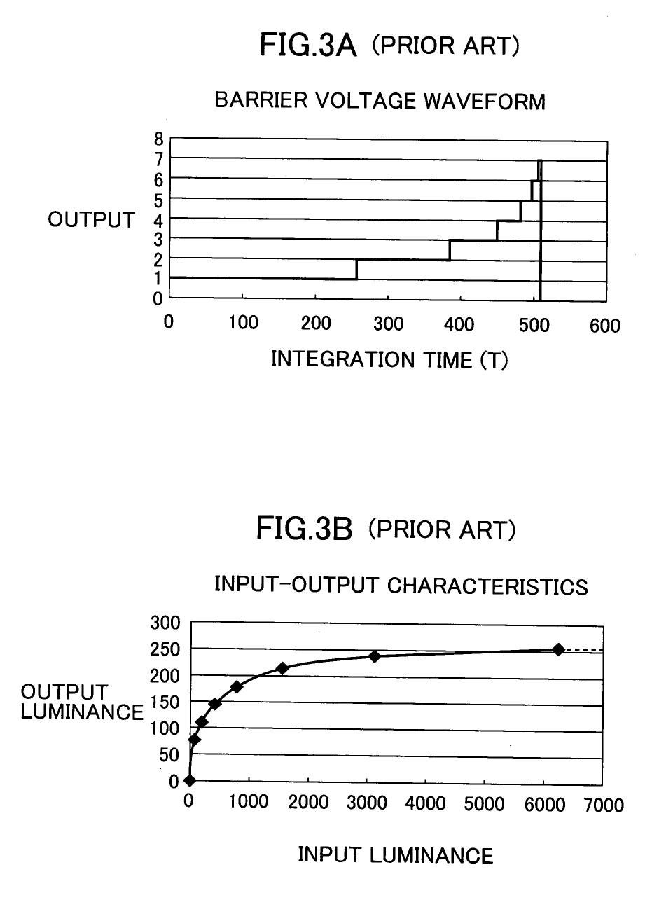

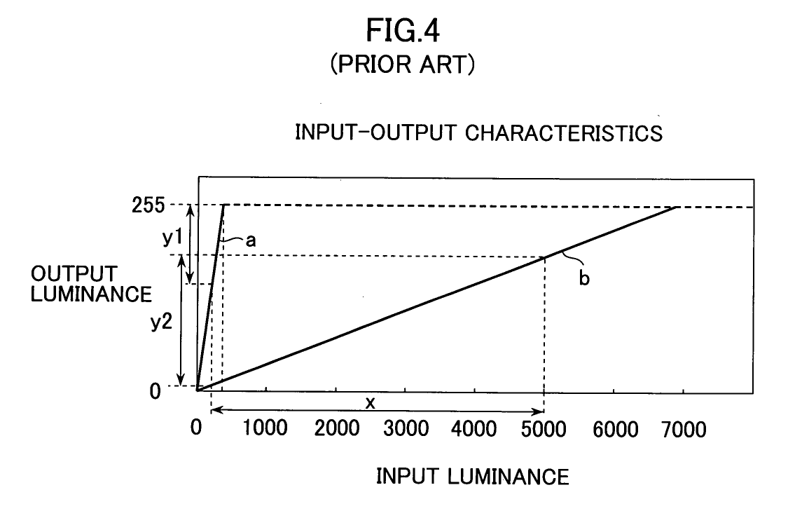

### DETAILED DESCRIPTION OF THE PREFERRED EMBODIMENTS

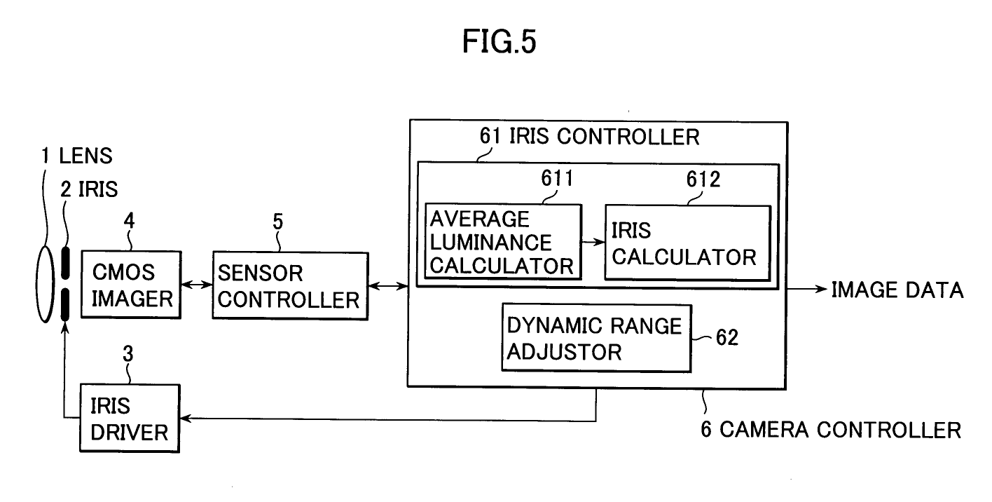

Preferred embodiments of the present invention are described in detail by referring to the accompanying drawings, wherein FIG. 5 is a block diagram illustrating one embodiment of the present invention.

In FIG. 5, lens 1 admits light from a subject. Iris 2 adjusts the amount of light introduced through lens 1. Iris driver 3 drives iris 2. CMOS imager 4 is an image sensor (CMOS sensor) which can capture color images and whose dynamic range can be varied. Light introduced through iris 2 is input to this CMOS imager in order to generate RGB (red-green-blue) image data. Sensor controller 5 controls CMOS imager 4.

Camera controller 6 performs chromatic processes, such as color interpolation, color adjustment, color matrix adjustment, white balance adjustment, gamma correction, knee correction, black level adjustment and chroma saturation adjustment, upon RGB data generated by CMOS imager 4. The camera controller thus converts the RGB data to 16-bit YCrCb (luminance and hue) image data and outputs the converted image data. In addition, camera controller 6 is provided with iris controller 61 and dynamic range adjuster 62. Iris controller 61 comprises average luminance calculator 611 and iris calculator 612, in order to determine the iris value according to the RGB data of CMOS imager 4 and let iris driver 3 make an iris value correction accordingly. Average luminance calculator 611 determines the average luminance of the RGB data. Iris calculator 612 calculates an iris value at which the average luminance of average luminance calculator 611 is adjusted to a desired average luminance, and lets iris driver 3 make an iris value correction accordingly. Dynamic range adjuster 62 corrects the logarithmic compression curve according to the RGB data of CMOS imager 4. Note that as many as, for example, 29 types of compression curve are previously made available.

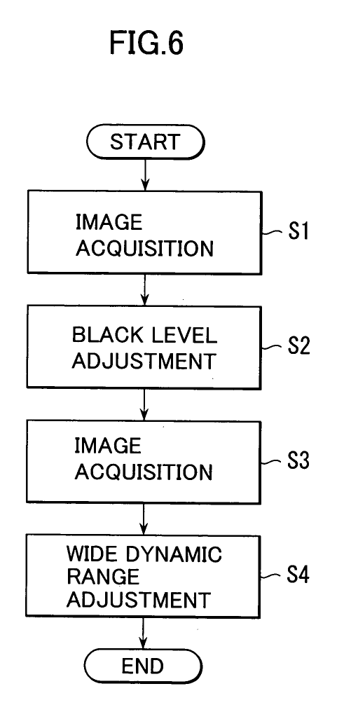

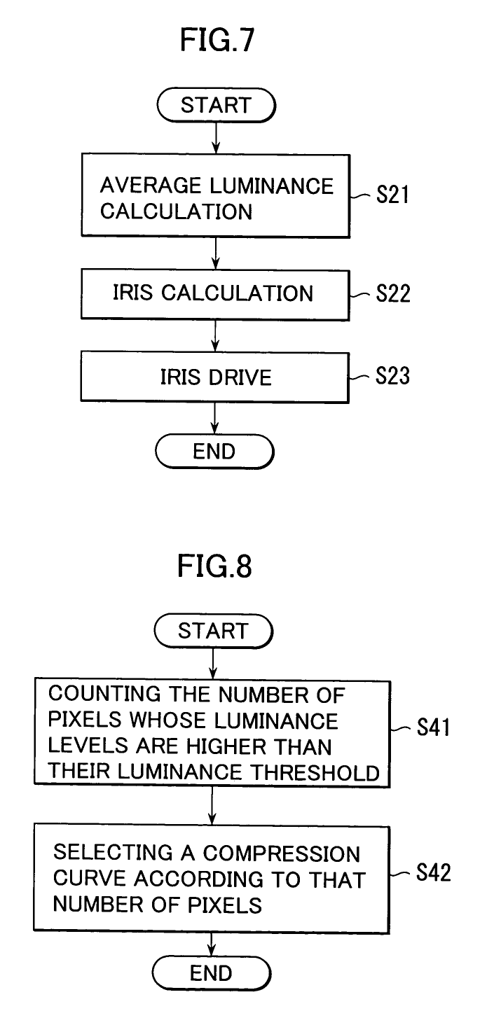

Such a system as discussed above is described hereinafter, wherein FIG. 6 is a flowchart illustrating the behavior of the system shown in FIG. 5, FIG. 7 is a flowchart illustrating the behavior of iris controller 61, and FIG. 8 is a flowchart illustrating the behavior of dynamic range adjuster 62.

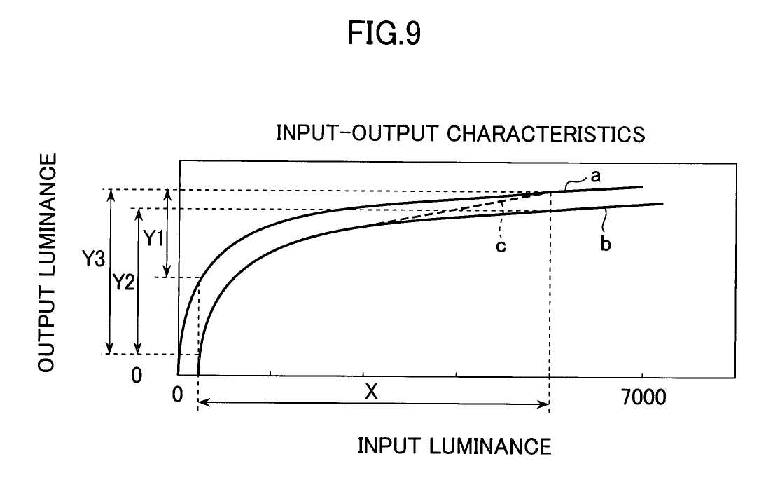

Sensor controller 5 outputs a barrier voltage to CMOS imager 4 and CMOS imager 4 in turn outputs RGB data to sensor controller 5. Sensor controller 5 then passes the RGB data to camera controller 6 (S1). This results in the input-output characteristics being represented as, for example, a logarithmic compression curve a illustrated in FIG. 9, providing output luminance range Y1 for input luminance range X.

Iris controller 61 adjusts the black level according to RGB data from sensor controller 5 and corrects iris 2 accordingly (S2). In other words, average luminance calculator 611 determines the average luminance of the RGB data (S21); based on this average luminance, iris calculator 612 calculates an iris value so that a desired average luminance is obtained (S22); and iris driver 3 is instructed to correct iris 2 according to this iris value (S23). As a result, -logarithmic compression curve a changes to logarithmic compression curve b, as illustrated in FIG. 9, providing output luminance range Y2 for input luminance range X.

Next, sensor controller 5 outputs a barrier voltage to CMOS imager 4 and CMOS imager 4 in turn outputs RGB data to sensor controller 5. Sensor controller 5 then passes the RGB data to camera controller 6 (S3). Based on this RGB data, dynamic range adjuster 62 corrects the compression curve of CMOS imager 4 (S4). In other words, dynamic range adjuster 62 counts the number of pixels whose brightness levels are higher than their brightness threshold, from the RGB data (S41). According to the number of pixels thus counted, dynamic range adjuster 62 selects a compression curve for sensor controller 5 (S42). As a result, logarithmic compression curve b changes to logarithmic compression curve c, as illustrated in FIG. 9, providing output luminance range Y3 for input luminance range X.

As described above, iris controller 61 determines an iris value according to RGB data so that iris driver 3 makes an iris value correction accordingly, iris 2 is adjusted, the distribution of dark-area levels is secured, and the compression curve is corrected by dynamic range adjuster 62. Consequently, it is possible to obtain wide dynamic-range optimum images.

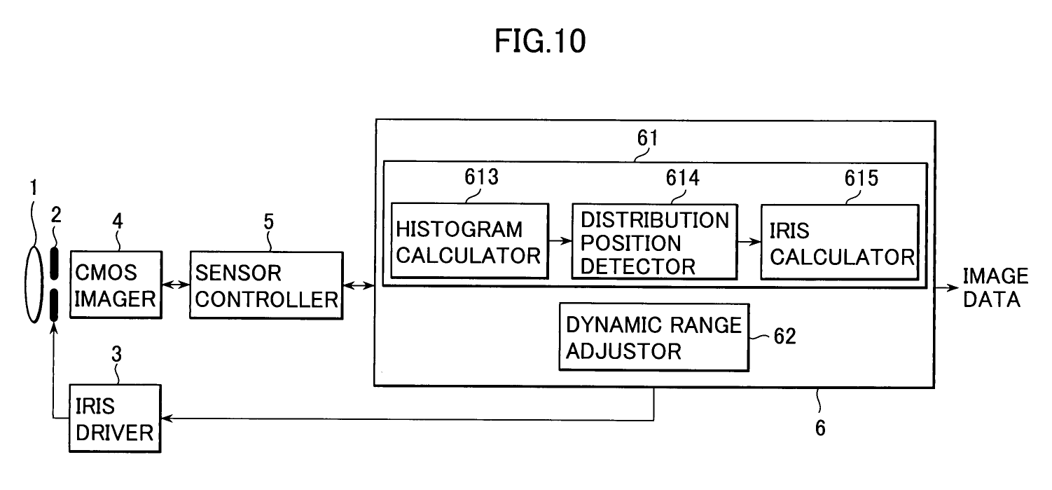

Now, another configuration of iris controller 61 is illustrated in FIG. 10 and described. Note that elements identical with those shown in FIG. 5 are referenced alike and excluded from the description given hereinafter. In FIG. 10, iris controller 61 comprises histogram calculator 613, distribution position detector 614 and iris calculator 615. Histogram calculator 613 determines the luminance histogram of image data. Distribution position detector 614 detects the distribution of the dark area according to the histogram of histogram calculator 613. According to the distribution detected by distribution position detector 614, iris calculator 615 calculates an iris value at which the distribution of the dark area is shifted to a desired position, and lets iris driver 3 make an iris value correction accordingly.

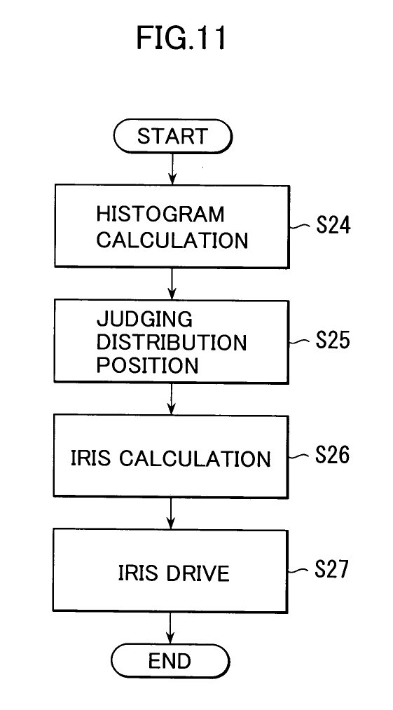

The behavior of such a system as discussed above is described hereinafter. FIG. 11 is a flowchart illustrating the behavior of iris controller 61 shown in FIG. 10. Note that behaviors identical with those of the system shown in FIG. 5 are excluded from the description given hereinafter.

Histogram calculator 613 calculates a histogram according to RGB data (S24). Based on this histogram, distribution position detector 614 detects the starting position of the dark-area distribution (S25).

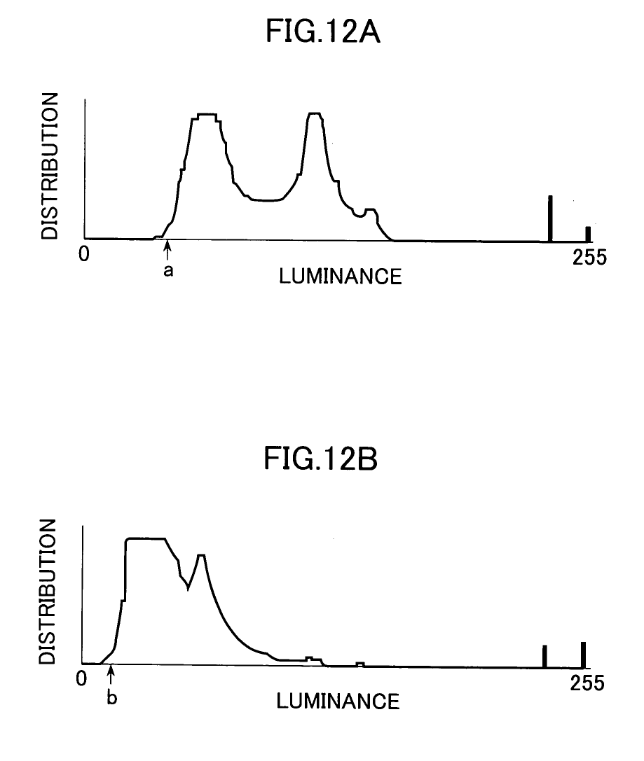

For example, the starting position a of the dark area is detected according to a given luminance frequency in the dark area, as illustrated in FIG. 12(A). Then, based on the distribution detected by distribution position detector 614, iris calculator 615 calculates an iris value at which the distribution of the dark area is shifted to a desired position, i.e., the distribution is shifted toward a lower-luminance position (S26). Based on this iris value, iris calculator 615 lets iris driver 3 correct iris 2 (S27).

Next, dynamic range adjuster 62 corrects the compression curve of CMOS imager 4, thus providing such a histogram as illustrated in FIG. 12(B). As a result, the starting position of the dark area is shifted to position b, thereby securing the distribution of dark-area luminance levels. Note that the average luminance of the histogram shown in FIG. 12(A) is 93.26, whereas the average luminance of the histogram shown FIG. 12(B) is 48.82. It is therefore understood that as with the case of the system illustrated in FIG. 5, the distribution of dark-area luminance levels can also be secured by decreasing the average luminance.

It should be noted that the present invention is not limited to the embodiments heretofore described. Although in one aspect of the present invention, the system is configured so that CMOS imager 4 supplies RGB data to camera controller 6 through sensor controller 5, it is possible to make CMOS imager 4 supply RGB data directly to camera controller 6.

In another aspect of the present invention, the system is configured so that iris controller 61 and dynamic range adjuster 62 make corrections according to RGB data. Alternatively, such corrections may be made according to YCrCb image data. In other words, the present invention is not limited to any specific type or types of image data.

What is claimed is:

1. A camera system for obtaining optimum images by controlling a compression curve for the dynamic range of an image sensor according to the brightness of a subject, comprising:
an iris for adjusting the amount of light introduced to said image sensor;
an iris driver for driving said iris;
an iris controller for determining an iris value according to the image data of said image sensor in order to let said iris driver make an iris value correction accordingly; and
a dynamic range adjuster for correcting said compression curve according to the image data of said image sensor.

2. The camera system of claim 1, wherein said iris controller comprises:
an average luminance calculator for determining the average luminance of said image data; and
an iris calculator for calculating an iris value at which the average luminance of said average luminance is adjusted to a desired average luminance, in order to let said iris driver make an iris value correction accordingly.

3. The camera system of claim 1, wherein said iris controller comprises:
a histogram calculator for determining the luminance histogram of said image data;
a distribution position detector for detecting the distribution of a dark area according to the luminance histogram of said histogram calculator; and
an iris calculator for calculating an iris value, according to said distribution detected by said distribution position detector, at which the distribution of said dark area is shifted to a desired position, in order to let said iris driver make an iris value correction accordingly.

4. The camera system of claim 1, 2 or 3, wherein said image sensor is a CMOS sensor.

5. A camera control method for obtaining optimum images by controlling a compression curve for the dynamic range of an image sensor according to the brightness of a subject, comprising the steps of:
iris control for determining an iris value according to the image data of said image sensor, in order to let an iris driver control an iris for adjusting the amount of light introduced to said image sensor; and
dynamic range adjustment for correcting a compression curve according to the image data of said image sensor.

6. The camera control method of claim 5, wherein said iris control step includes the steps of:
average luminance calculation for determining the average luminance of said image data; and
iris calculation for calculating an iris value at which said average luminance is adjusted to a desired average luminance, in order to let said iris driver make an iris value correction accordingly.

7. The camera control method of claim 5, wherein said iris control step includes the steps of:
histogram calculation for determining the luminance histogram of said image data;
distribution detection for detecting the distribution of a dark area according to said luminance histogram; and
iris calculation for calculating an iris value, according to said distribution, at which said dark-area distribution is shifted to a desired position, in order to let said iris driver make an iris value correction accordingly.

8. The camera control method of claim 5, 6 or 7, wherein said image sensor is a CMOS sensor.
